(19) United States
(12) Patent Application Publication
(10) Pub. No.: US 2022/0383425 A1
(43) Pub. Date: Dec. 1, 2022

(54) SYSTEM FOR MANAGEMENT OF GROUPS OF TRAVELERS

(71) Applicant: Keith McGuinness, Patchogue, NY (US)

(72) Inventor: Keith McGuinness, Patchogue, NY (US)

(21) Appl. No.: 17/330,636

(22) Filed: May 26, 2021

(51) Int. Cl. G06Q 50/00

(52) U.S. Cl. CPC G06Q 50/01

(57) ABSTRACT

The variations described herein relate to a system for group traveler management that may include an application on a smart device such as a smart phone, tablet, or computer device. The system may be constructed and arranged to receive and store user information for a plurality of users that may be travelers or local guides within a specific geographic location. The system may be constructed and arranged to systematically filter, correlate, and group similar traveler users together under a shared group traveler profile where each individual has mutual access to the same shared group profile. The system may also match guide users with existing traveler groups at a specified geographic location.

### TECHNICAL FIELD

The embodiments generally relate to the field of mobile applications and shared management of user groupings within a mobile application.

### BACKGROUND

Systems for fostering social media connectivity target individual users. A system for managing groups, and in particular groups of travelers, wherein the user may be a group of individuals, may provide for shared functionality across a variety of computing devices and smart devices for each of the individuals within the group.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

A system for group management may include grouping of multiple individuals into a single account on a group traveling platform. A system for management of groups of travelers may include an application in communication with a computing device or plurality of computing devices, such as smart phones. The application may include a registration module, a login module, traveler grouping module, a guide module, a location module, or graphical user interface (GUI) module. The application is constructed and arranged to systematically form a grouped profile based on user input and enable a plurality of users to share the grouped profile. The application may perform the steps of receiving and storing user information via the registration module in the memory by populating said user information into at least one of a traveler status, guide status, or seeking status to create one or more individual user profiles. The system may receive, via the login module, user login information and verifying the login information. The system may receive, via the location module, user location data. The system may group, via the grouping module, the one or more individual user profiles into at least one shared group traveler profile. The system may correlate, via the guide module, at least one individual user profile indicating guide status with the at least one shared group traveler profile. The system may provide, via the GUI module, a shared graphical user interface to the at least one shared group traveler profile.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a flowchart of a use case diagram according to some embodiments described herein;

FIG. 2 illustrates a block diagram of a computing device according to some embodiments described herein;

FIG. 3 illustrates a block diagram of a group traveling system according to some embodiments described herein;

FIG. 4 illustrates a GUI for a group traveling system according to some embodiments described herein;

FIG. 5 illustrates a GUI for a group traveling system according to some embodiments described herein;

FIG. 6 illustrates a GUI for a group traveling system according to some embodiments described herein; and

FIG. 7 illustrates a GUI for a group traveling system according to some embodiments described herein.

### DETAILED DESCRIPTION

The specific details of the single embodiment or variety of embodiments described herein are to the described system and methods of use. Any specific details of the embodiments are used for demonstration purposes only and no unnecessary limitations or inferences are to be understood from there.

It is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, apparatus, and/or computer program product at any possible technical detail level of integration. A computer application product can include, among other things, a computer-readable storage medium having computer-readable program instructions thereon for causing a processor to carry out aspects of the present disclosure.

As used herein, the term “user(s)” may refer to individuals, professionals, groups, entities, and any individuals using or relying on the system for managing groups of travelers described herein.

In this disclosure, the terms “device,” “devices,” “handheld device,” or “smart device” may include computers, phones, smart phones, tablets, laptops, televisions, smart speakers, smart cars, thermostats, locks, cameras, appliances, watches, or devices broadly included in the concept of the “internet of things.” Devices may be connected or in communication with other devices via any number of wireless protocols and non-wireless protocols. Wireless protocols may include, broadly, wireless internet, Wi-Fi, Li-Fi, near-field communication, ultra-high frequency radio, or the like. Devices may be connected or in communication with other devices such as local computers, phones, smart phones, tablets, laptops, televisions as well devices not considered local.

As used herein, “GUI” may refer to any graphical user interface that includes at least one interactive component between a user and the application. A GUI may include a plurality of fillable fields, clickable buttons, database displays, or the like. A GUI maybe adaptable for use on several devices such as computers, phones, smart devices, tablets, laptops, televisions, or the like.

In this disclosure, terms “store,” “storage,” “data store,” “data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory.

In this disclosure, “cloud” or “cloud storage” or “cloud-based system” may refer, generally, to software and services operating and communicating through the internet rather than on a local device. A cloud-based server system may enable various user devices to access the stored data on a server via the internet. The cloud or cloud-based services may enable a user or users to access the same or different files and applications from virtually any device. The files or applications being accessed and used may be stored on servers, computers, or any local or distant computer device. User devices may access the files or applications stored in the cloud via the Internet and most commonly via a wireless protocol as previously described herein.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In this disclosure, the various embodiments may be a system, method, apparatus, and/or computer program product at any possible technical detail level of integration. A computer application product can include, among other things, a computer-readable storage medium having computer-readable program instructions thereon for causing a processor to carry out aspects of the present disclosure.

In general, the embodiments described herein relate to a system for group management that may include an application on a smart device such as a smart phone, tablet, or computer device. The system may be constructed and arranged to, via a plurality of modules, receiving store user information for a plurality of users that may be travelers or local guides within a specific geographic location. Traveler users may use the system to indicate their status as travelers and to seek out other travelers or local guides in similar geographic locations. Similarly, traveler users and local guide users may utilize the application to search desired geographic locations prior to arriving in said location such that they may meet up with other travelers and local guides via the application. The application may operate on a smart device or computing device, such as a smartphone, and may be in communication with various other instances of the application on various other computing devices via network communication. The system may be constructed and arranged to identify and correlate travelers having similar traveler status, geographic location, desired geographic destination, age groups, spoken languages, or the like. The system may be constructed and arranged to group identified similar traveler users and provide a shared user profile for grouped individuals. The system may be constructed and arranged to provide a shared user profile accessible by all grouped individuals, the shared user profile being constructed and arranged to allow any of the grouped individuals access thereto, modification of, and use within. The shared group profile may be constructed and arranged to allow individual users to message each other within the traveler group shared profile.

The system may be constructed and arranged to allow individual users to store a variety of information including individual user information such as name, contact information, birthdate, origin location, interests, and other profile information. The system may allow a user to set traveler status has one of a variety of different options. For example, but not limited to, a user may indicate that they are a traveler user (traveler status) or a local guide user (guide status). Traveler status may indicate that the individual user is seeking travel destinations and may also be seeking similarly profiled users having traveler status seeking to travel to a similar location. Similarly, a user may indicate that they are a guide user seeking to assist traveler users in the current location of the guide user. The system may be constructed and arranged to group similar traveler users in a location with a local guide user such that the guide user may assist the traveler users in their respective location. The system may be constructed and arranged to allow traveler users to indicate that they are seeking similar traveler users, traveler users to indicate that they are seeking guide users, and guide users to indicate that they are seeking traveler users. In some variations, the system may be constructed and arranged to prevent guide users from seeking other guide users in a specific location.

The system may include a registration module constructed and arranged to receive and store user information within the memory of a computing device or on a network-based server, such as, but not limited to, cloud storage. The registration module may be constructed and arranged to receive information such as traveler status, guide status, seeking status, geographic location, desired geographic destination, age groups, spoken languages, or the like. The registration module may also be constructed and arranged to allow a user to modify their input after initial registration.

The system may include a login module constructed and arranged to allow a user to sign up for system functionality. The login module may also receive information from a user such as name, phone number, email, passwords, and other secure login information such as biometric data. The login module may include secure verification methods such as a one-time password or captcha functionality security measures. The login module may include password recovery and password reset functionality.

The system may include a traveler grouping module constructed and arranged to group one or more individual user profiles into at least one shared group traveler profile. The traveler grouping module may receive, via the registration module, user information such as traveler status, guide status, or seeking status to create one or more individual user profiles. The traveler grouping module may receive user location information from a user's smart device via a location module to supplement the at least one individual user profile. The traveler grouping module may systematically identify one or more individual user profiles having similar user location information, traveler status, guide status, or seeking status The traveler grouping module may systematically correlate user information based on at least one of user location information, traveler status, guide status, or seeking status. The traveler grouping module may group the one or more individual user profiles based on relevant correlations in user location information, traveler status, guide status, or seeking status. The traveler grouping module may group individual users within at least one shared group traveler profile having mutual, shared profile functionality.

A guide module, in conjunction with the traveler grouping module, may group least one individual user profile indicating guide status with the at least one shared group traveler profile.

A location module may be constructed and arranged to determine, via GPS functionality or otherwise, the current location of a user or user device, or the location of a desired travel destination in which a traveler user or guide user is seeking to meet other users.

A GUI module may be constructed and arranged to system information such as location data status data, messaging functionality, group user profile data, and may allow a user and permit a user to navigate and interact with the system. The GUI may be constructed and arranged to allow a user to search and filter various geographic locations, traveler users, guide users, seeking statuses, and group profiles. The GUI module may provide a shared graphical user interface to the one or more individual user profiles via at least one shared group traveler profile. The GUI module may provide, via a shared graphical user interface over a network in operable communication with the least one computing device, access to a shared group traveler profile in which each of the grouped individual user profiles may view, edit, or share individual user profile information and location data.

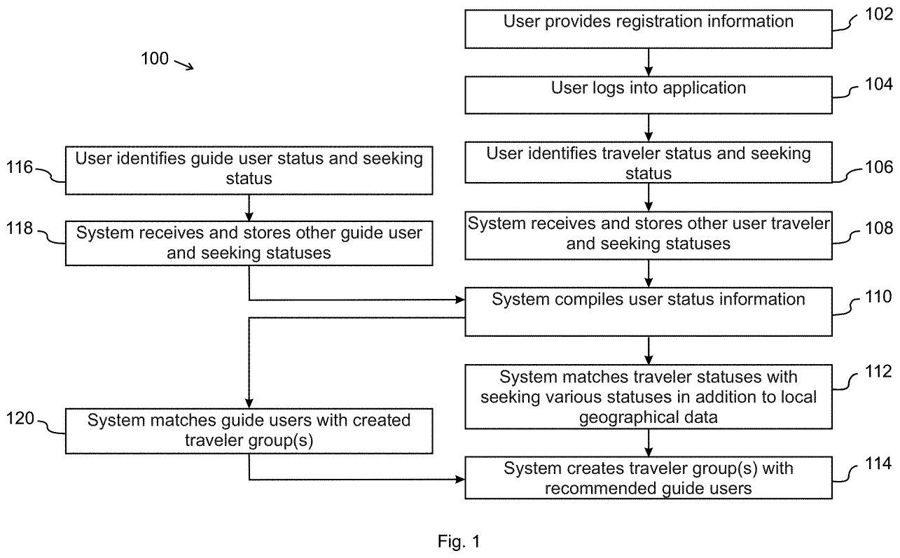

FIG. 1 is it use case diagram illustrating a system 100 for group traveler management. The system 100 may execute the following steps. Step 102 may include a user providing registration information which may be received and stored by the system. Step 104 may include a user logging into the application via the login module. Step 106 may include a user indicating a traveler status and seeking status such as, but not limited to, a United States based traveler seeking Spanish speaking travelers in a region of Mexico. Step 116 may include a user identifying themselves as having guide user status and seeking status such as, but not limited to, a Mexico-based guide user seeking Spanish speaking travelers in region of Mexico. According to step 108, the system may receive and store user traveler and seeking statuses. Similarly, in step 118, the system may receive and store guide user and seeking statuses. In step 110, the system may compile both traveler use and guide user status information and group travelers having similar traveler statuses an seeking statuses in similar geographic locations. The system may also, as in step 120, optionally match guide users with traveler users. As in step 114, the system may create groups of matched traveler users together in addition to grouping an optional guide user.

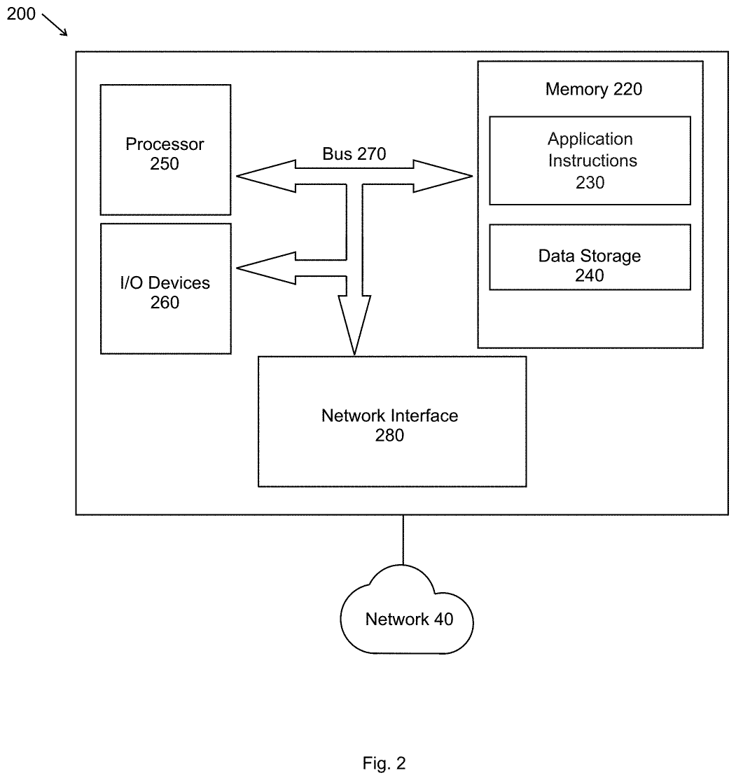

FIG. 2 is a diagram illustrating a non-limiting example of computing device 200 implementing a system for management of group travelers. The computing device 200 may include a standalone computer or mobile computing device, workstation, network computer, laptop, or the like. The computing device 200 may include a processor 250 coupled to a memory 220 via a bus 270. The processor 250 may be constructed and arranged for the execution of computer readable program instructions including the system for management of group travelers instructions 230. The bus 270 may be any of several types of bus structures including a memory bus or memory controller, a peripheral bus, and a local bus using any of a variety of bus architectures. The computing device 200 may include various input and output devices 260 in operable communication with the processor 250. The input and output devices 260 may include a variety of devices such as video devices, audio devices, displays, or the like. In some instances, the input and output devices 260 may be separate from the computing device 200. The computing device 200 may include memory 220 which may include computer readable application instructions 230. The memory 220 may include data storage 240 which may include data accessible by the application instructions. The computing device 200 main include a network interface 280 constructed and arranged to allow the computing device 200 to communicate with and over a network 40. Various computing devices 200 executing the system for management of group travelers instructions 230 may be in operable communication with one another over the network 40.

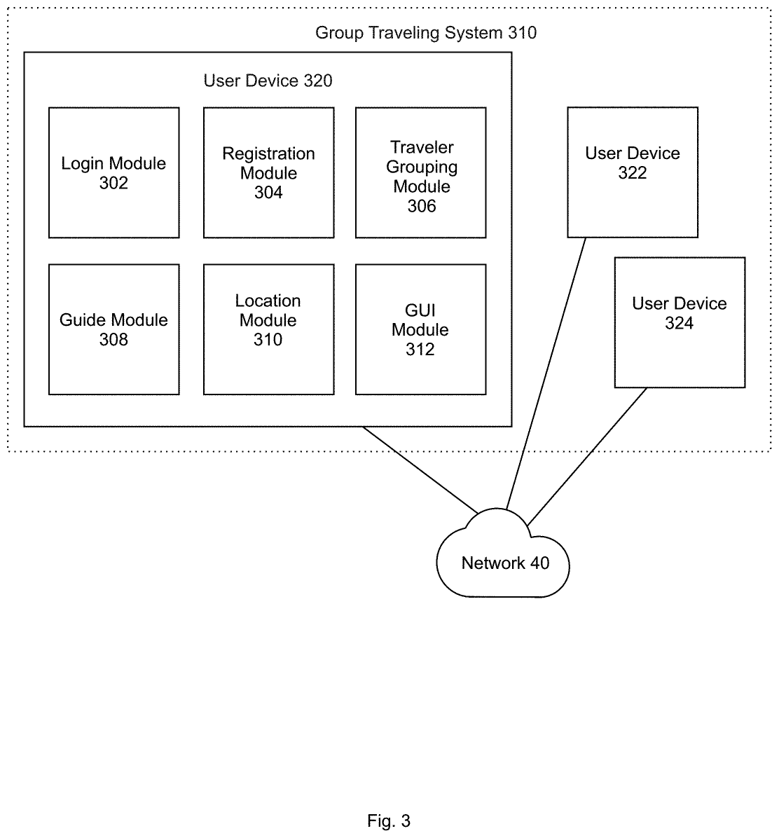

FIG. 3 illustrates a system for management of group travelers 310 that may include a variety of user devices 320, 322, and 324. Each of the user devices may include a login module 302, a registration module, 304 a traveler grouping module 306, a guide module 308, a location module 310, and a GUI module 312. The various user computing devices 320, 322, and 324 maybe in operable communication with one another over a network 40 such that the system may receive, store, group travelers and guide users, and provide a shared group travelers profile to each of the user computing devices.

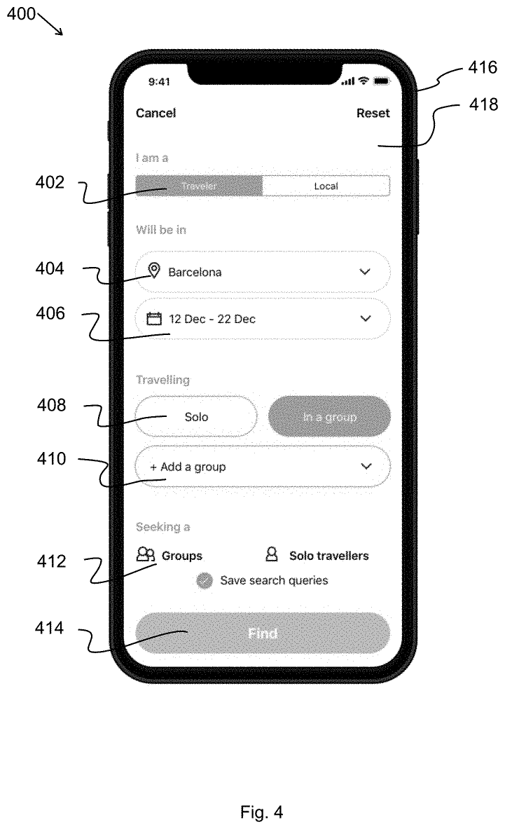

FIG. 4 illustrates a variation of a GUI 418 for a system for management of group travelers 400 executed on a computing device 416, wherein the GUI 418 provides a user the capacity to indicate traveler or guide status 402, geographic destination 404, traveling dates 406, and individual, solo, or group traveling status 408. The GUI 418 may also provide the capacity for a user to select a pre-existing group 410 as created by the system. The GUI 418 may provide the capacity for a user to indicate seeking status 412 such as groups or solo travelers. The GUI 418 may provide the capacity for a user to search 414 destinations, other users, and groups according to the user selected filters and variables.

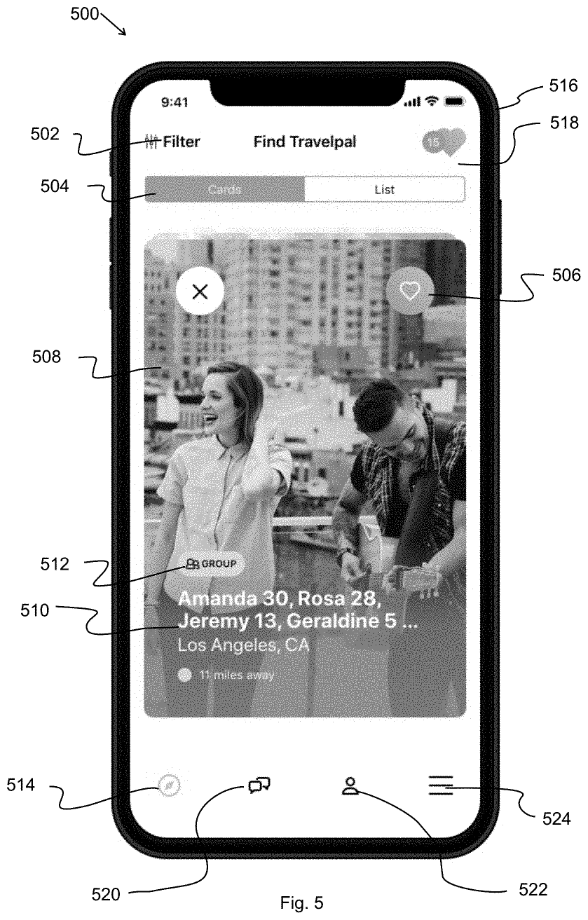

FIG. 5 illustrates a variation of a GUI 518 for a system for management of group travelers 500 executed on a computing device 516, the GUI 518 may additionally be constructed and arranged to provide a user the capacity to filter search results 502, as discussed above in FIG. 4, In addition, traveler user and guide user viewing options 504 may be viewed as a list or as cards. The GUI 518 may provide images 508 of groups or users including information indicating user or group status 512, users within a group 510, and favoriting 506 of users or groups. The GUI 518 may additionally provide location functionality 514, messaging functionality 520, individual user profile settings 522 and menu navigation functionality 524.

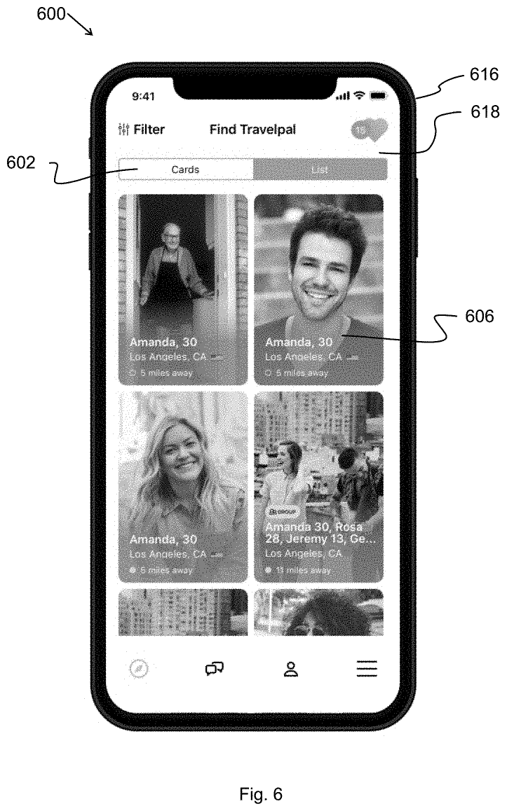

FIG. 6 illustrates a variation of a GUI 618 for a system for management of group travelers 600 executed on a computing device 616, the GUI 618 may provide further capacity to filter search results as a list 602 including displaying various users and groups 606 which may be scrolled through.

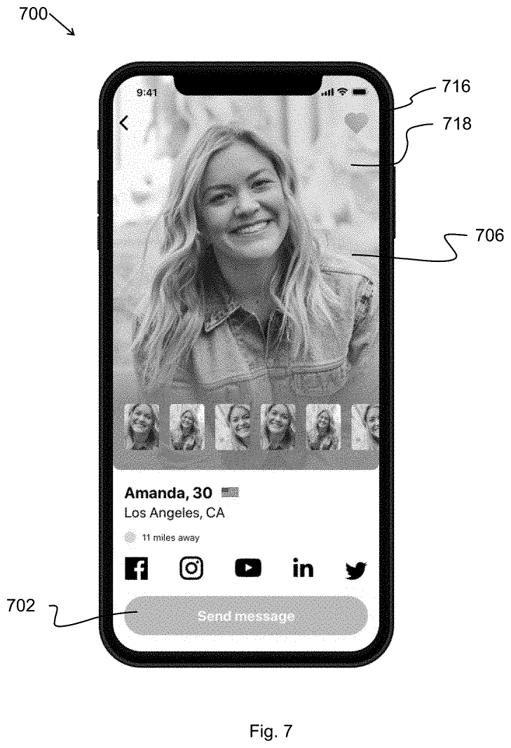

FIG. 7 illustrates a variation of a GUI 718 for a system for management of group travelers 700 executed on a computing device 716, the GUI 718 may be constructed and arranged to allow a user to select another user or group to view the user profile 706 including the display of relevant images, location data, age data, social media platform integration, and messaging functionality 702.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a system for management of groups of travelers, may include at least one computing device; a memory that stores computer-executable components; a processor that executes the computer-executable components stored in the memory, wherein the computer-executable components include an application in communication with the computing device, the application including at least one of a registration module, a login module, traveler grouping module, a guide module, a location module, or GUI module. The application is constructed and arranged to systematically form a grouped profile based on user input and enable a plurality of users to share the grouped profile. The application may perform the steps of receiving and storing user information via the registration module in the memory by populating said user information into at least one of a traveler status, guide status, or seeking status to create one or more individual user profiles; receiving, via the login module, user login information and verifying the login information; receiving, via the location module, user location data; grouping, via the grouping module, the one or more individual user profiles into at least one shared group traveler profile; correlating, via the guide module, at least one individual user profile indicating guide status with the at least one shared group traveler profile; grouping the at least one individual user profile indicating guide status with the at least one shared group traveler profile; and providing, via the GUI module, a shared graphical user interface to the at least one shared group traveler profile.

Variation 2 may include a system for management of group travelers as in variation 1, wherein the login module includes at least one secure verification method.

Variation 3 may include a system for management of group travelers as in any of variations 1 through 2, wherein the registration module is constructed and arranged to receive and store information relating to username, contact information, date of birth, or interests.

Variation 4 may include a system for management of group travelers as in any of variations 1 through 3, where in the at least one computing device is a smart phone.

Variation 5 may include a system for management of group travelers as in any of variations 1 through 4, wherein the location module is constructed and arranged to receive location information via GPS functionality of the at least one computing device.

Variation 6 may include a system for management of group travelers as in any of variations 1 through 5, wherein the location module is constructed and arranged to receive location information of the at least one computing device via user input of desired location information.

Variation 7 may include a system for management of group travelers as in any of variations 1 through 6, wherein the location module is constructed and arranged to indicate proximity of user profiles indicating guide status to the at least one shared group traveler profile.

Variation 8 may include a system for management of group travelers as in any of variations 1 through 7, further including a messaging module constructed and arranged to allow users grouped within the at least one shared group traveler profile to message each other individually or as a group.

Variation 9 may include a system for management of group travelers as in any of variations 1 through 8, wherein providing, via the GUI module, a shared graphical user interface to the one or more individual user profiles via the at least one shared group traveler profile includes providing, over a network in operable communication with the least one computing device, access to a shared group traveler profile in which each of the grouped individual user profiles may view, edit, or share individual user profile information and location data.

Variation 10 may include a system for management of groups of travelers, including at least one computing device in communication with a network; a memory that stores computer-executable components; a processor that executes the computer-executable components stored in the memory. The computer-executable components include an application in communication with the computing device, the application including at least one of a registration module, a login module, traveler grouping module, a guide module, a location module, or GUI module. The application may be constructed and arranged to systematically form a grouped profile based on user input and enable a plurality of users to share the grouped profile. The application may be constructed and arranged for receiving and storing user information via the registration module in the memory by populating said user information into at least one of a traveler status, guide status, or seeking status to create one or more individual user profiles; receiving, via the login module, user login information and verifying the login information; receiving, via the location module, user location data; grouping, via the grouping module, the one or more individual user profiles into at least one shared group traveler profile; and providing, over a network in operable communication with the least one computing device, access to a shared group traveler profile in which each of the grouped individual user profiles may view, edit, or share individual user profile information and location data.

Variation 11 may include a system for management of group travelers as in variation 10, further including, after grouping, via the grouping module, the one or more individual user profiles into at least one shared group traveler profile correlating, via the guide module, at least one individual user profile indicating guide status with the at least one shared group traveler profile and grouping the at least one individual user profile indicating guide status with the at least one shared group traveler profile.

Variation 12 may include a system for management of group travelers as in any of variations 10 through 11, wherein the location module is constructed and arranged to receive location information via GPS functionality of the at least one computing device.

Variation 13 may include a system for management of group travelers as in any of variations 10 through 12, wherein the location module is constructed and arranged to receive location information of the at least one computing device via user input of desired location information.

Variation 14 may include a system for management of group travelers as in any of variations 10 through 13, wherein the location module is constructed and arranged to indicate proximity of user profiles indicating guide status to the at least one shared group traveler profile.

Variation 15 may include a system for management of group travelers as in any of variations 10 through 14, wherein the GUI module is module constructed and arranged to allow users grouped within the at least one shared group traveler profile to message each other individually or as a group.

According to variation 16, a system for management of groups of travelers may include a plurality of computing devices in operable communication with one another via a network, each including a memory that stores computer-executable components; a processor that executes the computer-executable components stored in the memory, wherein the computer-executable components include: an application in communication with the computing device, the application including at least one of a registration module, a login module, traveler grouping module, a guide module, a location module, or GUI module. Wherein the application is constructed and arranged to systematically form a grouped profile based on user input and enable a plurality of users to share the grouped profile. The system may perform the steps of receiving and storing user information via the registration module in the memory by populating said user information into at least one of a traveler status, guide status, or seeking status to create one or more individual user profiles; receiving and storing user location information from a user's smart device via the location module to supplement the at least one individual user profile; correlating user information based on at least one of user location information, traveler status, guide status, or seeking status; identifying one or more individual user profiles having similar user location information, traveler status, guide status, or seeking status; grouping the one or more individual user profiles; forming a shared group profile including the grouped one or more individual user profiles such that the plurality of computing devices may communicate with each other via the shared group profile; and providing a shared graphical user interface to the grouped one or more individual user profiles wherein each user associated with each individual grouped one or more individual user profiles has access to the same information, communication means, and capabilities within the system.

Variation 17 may include a system for management of group travelers as in variation 16 wherein the location module is constructed and arranged to receive location information via GPS functionality of the at least one computing device.

Variation 18 may include a system for management of group travelers as in any of variations 16 through 17 wherein the location module is constructed and arranged to receive location information of the at least one computing device via user input of desired location information.

Variation 19 may include a system for management of group travelers as in any of variations 16 through 18 wherein the location module is constructed and arranged to indicate proximity of user profiles indicating guide status to the at least one shared group traveler profile.

Variation 20 may include a system for management of group travelers as in any of variations 16 through 19 wherein the GUI module is constructed and arranged to allow users grouped within the at least one shared group traveler profile to message each other individually or as a group.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

1. A system for management of groups of travelers, comprising:
at least one computing device;
a memory that stores computer-executable components;
a processor that executes the computer-executable components stored in the memory, wherein the computer-executable components comprise:
an application in communication with the computing device, the application comprising at least one of a registration module, a login module, traveler grouping module, a guide module, a location module, or GUI module;
wherein the application is constructed and arranged to systematically form a grouped profile based on user input and enable a plurality of users to share the grouped profile, comprising:
receiving and storing user information via the registration module in the memory by populating said user information into at least one of a traveler status, guide status, or seeking status to create one or more individual user profiles;
receiving, via the login module, user login information and verifying the login information;
receiving, via the location module, user location data;
grouping, via the grouping module, the one or more individual user profiles into at least one shared group traveler profile;
correlating, via the guide module, at least one individual user profile indicating guide status with the at least one shared group traveler profile;
grouping the at least one individual user profile indicating guide status with the at least one shared group traveler profile; and
providing, via the GUI module, a shared graphical user interface to the at least one shared group traveler profile.

2. A system for management of groups of travelers as in claim 1, wherein the login module comprises at least one secure verification method.

3. A system for management of groups of travelers as in claim 1, wherein the registration module is constructed and arranged to receive and store information relating to username, contact information, date of birth, or interests.

4. A system for management of groups of travelers as in claim 1, wherein the at least one computing device is a smart phone.

5. A system for management of groups of travelers as in claim 1, wherein the location module is constructed and arranged to receive location information via GPS functionality of the at least one computing device.

6. A system for management of groups of travelers as in claim 1, wherein the location module is constructed and arranged to receive location information of the at least one computing device via user input of desired location information.

7. A system for management of groups of travelers as in claim 1, wherein the location module is constructed and arranged to indicate proximity of user profiles indicating guide status to the at least one shared group traveler profile.

8. A system for management of groups of travelers as in claim 1, further comprising a messaging module constructed and arranged to allow users grouped within the at least one shared group traveler profile to message each other individually or as a group.

9. A system for management of groups of travelers as in claim 1, wherein providing, via the GUI module, a shared graphical user interface to the one or more individual user profiles via the at least one shared group traveler profile comprises:
providing, over a network in operable communication with the least one computing device, access to a shared group traveler profile in which each of the grouped individual user profiles may view, edit, or share individual user profile information and location data.

10. A system for management of groups of travelers, comprising:
at least one computing device in communication with a network;
a memory that stores computer-executable components;
a processor that executes the computer-executable components stored in the memory, wherein the computer-executable components comprise:
an application in communication with the computing device, the application comprising at least one of a registration module, a login module, traveler grouping module, a guide module, a location module, or GUI module;
wherein the application is constructed and arranged to systematically form a grouped profile based on user input and enable a plurality of users to share the grouped profile, comprising:
receiving and storing user information via the registration module in the memory by populating said user information into at least one of a traveler status, guide status, or seeking status to create one or more individual user profiles;
receiving, via the login module, user login information and verifying the login information;
receiving, via the location module, user location data;
grouping, via the grouping module, the one or more individual user profiles into at least one shared group traveler profile; and
providing, over a network in operable communication with the least one computing device, access to a shared group traveler profile in which each of the grouped individual user profiles may view, edit, or share individual user profile information and location data.

11. A system for management of groups of travelers as in claim 10, further comprising, after grouping, via the grouping module, the one or more individual user profiles into at least one shared group traveler profile:
correlating, via the guide module, at least one individual user profile indicating guide status with the at least one shared group traveler profile; and
grouping the at least one individual user profile indicating guide status with the at least one shared group traveler profile.

12. A system for management of groups of travelers as in claim 10, wherein the location module is constructed and arranged to receive location information via GPS functionality of the at least one computing device.

13. A system for management of groups of travelers as in claim 10, wherein the location module is constructed and arranged to receive location information of the at least one computing device via user input of desired location information.

14. A system for management of groups of travelers as in claim 10, wherein the location module is constructed and arranged to indicate proximity of user profiles indicating guide status to the at least one shared group traveler profile.

15. A system for management of groups of travelers as in claim 10, wherein the GUI module is constructed and arranged to allow users grouped within the at least one shared group traveler profile to message each other individually or as a group.

16. A system for management of groups of travelers, comprising:
a plurality of computing devices in operable communication with one another via a network, each comprising:
a memory that stores computer-executable components;
a processor that executes the computer-executable components stored in the memory, wherein the computer-executable components comprise:
an application in communication with the computing device, the application comprising at least one of a registration module, a login module, traveler grouping module, a guide module, a location module, or GUI module;
wherein the application is constructed and arranged to systematically form a grouped profile based on user input and enable a plurality of users to share the grouped profile, comprising:
receiving and storing user information via the registration module in the memory by populating said user information into at least one of a traveler status, guide status, or seeking status to create one or more individual user profiles;
receiving and storing user location information from a user's smart device via the location module to supplement the at least one individual user profile;
correlating user information based on at least one of user location information, traveler status, guide status, or seeking status;
identifying one or more individual user profiles having similar user location information, traveler status, guide status, or seeking status;
grouping the one or more individual user profiles;
forming a shared group profile comprising the grouped one or more individual user profiles such that the plurality of computing devices may communicate with each other via the shared group profile; and
providing a shared graphical user interface to the grouped one or more individual user profiles wherein each user associated with each individual grouped one or more individual user profiles has access to the same information, communication means, and capabilities within the system.

17. A system for management of groups of travelers as in claim 16, wherein the location module is constructed and arranged to receive location information via GPS functionality of the at least one computing device.

18. A system for management of groups of travelers as in claim 16, wherein the location module is constructed and arranged to receive location information of the at least one computing device via user input of desired location information.

19. A system for management of groups of travelers as in claim 16, wherein the location module is constructed and arranged to indicate proximity of user profiles indicating guide status to the at least one shared group traveler profile.

20. A system for management of groups of travelers as in claim 16, wherein the GUI module is constructed and arranged to allow users grouped within the at least one shared group traveler profile to message each other individually or as a group.
